(19) United States
(12) Patent Application Publication
(10) Pub. No.: US 2008/0202115 A1
(43) Pub. Date: Aug. 28, 2008

(54) Machine and integrated hybrid drive with regenerative hydraulic force assist

(75) Inventor: David Geiger, Orchard Park, NY (US)

Correspondence Address: ALEX RHODES;UNIT NO. 9, 50168 PONTIAC TRAIL, WIXOM, MI, 48393, US

(73) Assignee: Geiger Innovative Technology Inc., a New York Corporation

(21) Appl. No.: 11/711,530

(22) Filed: Feb. 27, 2007

(51) Int. Cl. B60T 17/22

(52) U.S. Cl. 60/534; 100/35; 60/533; 60/545; 74/841

(57) ABSTRACT

A mechanical-hydraulic machine and an integrated hybrid drive with a regenerative force assist for eliminating pumps and intensifiers and reducing the energy consumption, operating costs, investment costs, weight and size of machines and improving their performance. The integrated hybrid drive is comprised of common mechanical and hydraulic components. The regenerative hydraulic force assist converts gravitational and deceleration forces of the machine into fluid pressure, stores the fluid pressure and applies the fluid pressure to clamping of dies or molds and/or performing machine operations. A closed loop control system controls the flow of fluid between the hydraulic drive and regenerative force assist.

### FIELD OF THE INVENTION

This invention relates to machines and more particularly to a mechanical-hydraulic machine and an integrated hybrid drive with a regenerative force assist.

### BACKGROUND OF THE INVENTION

Large machines, such as stamping presses, die casting machines, extrusion presses, powder metal compacting machines and injection molding machines share certain aspects. One shared aspect is that members, such as pallets and rams open and close dies or molds and/or perform operations, such as clamping, stamping, extruding, powder metal compacting, and the like. Another aspect is that high forces clamp and perform stamping, forging, machining, metal powder compacting operations. Other shared aspects are high investments, high operating costs, pollution, noise and frequent service.

Machines are divided in accordance with their drives. The drives, also called actuators, clamp and perform other operations. They are mainly mechanical and hydraulic. The type of drive determines the force progression during a machine cycle. By way of an example, stamping presses which use mechanical drives are commonly referred to as mechanical presses while stamping presses that use hydraulic drives are commonly referred to as hydraulic presses. Vertical mechanical presses are popular because they rapidly move rams and pallets while hydraulic presses are slower and consume more energy. The output (stamping) forces of vertical stamping presses consist of drive and gravitational forces.

Machines are also divided into single acting machines, double acting machines and multiple acting machines, according to the number of output members that perform work. For example, stamping presses that have a single ram for performing a stamping operation are referred to as single acting presses whereas presses with two rams, one for clamping the outer edges of a blank to prevent wrinkles and another for performing a stamping operation are referred to as double acting presses. A double acting machine requires two independent output members. Some machines, such as die casting machines, powder metal compaction machines and special machines can have multiple drives, i.e. have more than two independent output members.

Stamping presses with mechanical drives can reach higher cycles per time than hydraulic presses because output force progressively increases towards a bottom dead center. However, mechanical stamping presses are large, heavy, noisy, expensive to operate and require frequent service. Hydraulic stamping presses are generally quieter, lower in weight and more compact, since their output force is constant during a stroke of a palette or ram. However, hydraulic driven presses have lower numbers of cycles per time, are generally complex (require pumps, intensifiers, complex controls), lack environmental cleanliness (oil leaks), consume more energy and are more expensive to operate because of pump and fluid friction.

Existing drive technology is either force limited or speed limited depending upon a drive's design. Producing sequential energy efficient high speed/low force movements to reduce cycle times followed by high force/low speed movements to perform operations is beyond the capabilities of current machines.

A need exists for a compact, low weight, energy efficient, environmental friendly machine, capable of high cycles per unit time. Hybrid drives have been developed to satisfy this need. Although their inventors allege that they are somewhat improved over mechanical and hydraulic drives, they are relatively costly, large, complex and consume large amounts of energy.

Inaba et al. U.S. Pat. No. 4,968,239; Leonhartsbereger et al. U.S. Pat. No. 5,345,766; and Morita et al. U.S. Pat. No. 6,439,875 are exemplary of recent developments in machine drives.

Inaba et al. U.S. Pat. No. 4,968,239 discloses a—mechanical-mechanical drive mold clamping apparatus for a plastic molding machine comprised of coarse and fine pitch ball screw and nut drive, an electric motor, clutches, a control and a brake. The coarse pitch ball screw and nut drive provides a high speed/low force displacement. The fine pitch ball screw and nut drive provides a low speed/high clamping force.

Leonhartsbereger et al. U.S. Pat. No. 5,345,766 discloses a drive for a plastic molding machine comprised of an electric motor, a ball screw and nut drive and a hydraulic intensifier. The ball screw and nut drive rapidly advances a mold member until a resistance is encountered. When the resistance prevents further movement, the hydraulic intensifier supplies a high clamping force.

Morita et al. U.S. Pat. No. 6,439,875 discloses a drive for a plastic molding machine comprised of an electric motor, a ball screw and nut drive and a hydraulic pump. The ball screw and nut drive rapidly advances a mold member to a position where the hydraulic pump supplies a high clamping force.

Neither Inaba et al. U.S. Pat. No. 4,968,239, nor Leonhartsbereger et al. U.S. Pat. No. 5,345,766, nor Morita et al. U.S. Pat. No. 6,439,875 disclose or suggest a mechanical-hydraulic machine drive with a regenerative hydraulic force assist. It would be generally desirable to provide a drive for machines which has the capability of high-speed low-force displacements followed by a high force displacement which does not require a large electric motor, hydraulic pump or intensifier.

### SUMMARY OF THE INVENTION

The present invention is an energy efficient mechanical-hydraulic machine with an integrated hybrid drive and a regenerative hydraulic force assist. The invention resides in the ability of its components, separately and in combination, to reduce energy consumption and provide the numerous, substantial benefits disclosed herein.

The invention provides numerous benefits over machines with mechanical, hydraulic and hybrid drive machines. One characterizing feature of the machine is that at least one output member is driven by a mechanical drive and a hydraulic drive. Another feature of the invention is that the mechanical and the hydraulic drives share common members. For example, one member of the machine functions as a hydraulic cylinder for the hydraulic drive and as a housing for the mechanical drive. Another member functions as a piston for the hydraulic drive and as a ball nut for the mechanical drive. Another member functions as an output member for the mechanical drive and the hydraulic drive.

The integration of mechanical drive components with the hydraulic drive components reduces energy consumption by eliminating hydraulic lines that cause friction losses and decreases cycle time. It reduces weight, size and cost and improves durability and environmental cleanliness by reducing fluid leakage.

Another feature is a regenerative hydraulic force assist that eliminates hydraulic pumps and intensifiers and reduces electric motor size. This feature further reduces energy consumption by eliminating friction losses that occur in pumps and intensifiers and reducing electric motor current draw. It further reduces cycle time, weight, size and cost and improves durability and environment cleanliness by eliminating components and sources of fluid leakage.

The benefits of the invention were confirmed by a cost benefit comparison of a manufacturer's one hundred ton mechanical stamping press with the present invention. The results of the comparison show that energy consumption and annual operating costs are substantially reduced. The annual savings in operating costs, excluding the savings in fixed costs, was impressive, about $9,910. The reduction in cycle time reduced the requirement for machines and employees, thereby reducing employment and investment costs. The savings were so high that the return on investment was projected to be one year. Other important benefits included, easier OSHA compliance, reduced installation costs, improved part quality and reduced maintenance costs The integrated hybrid drive, which by itself is believed to be novel, is comprised of a mechanical drive, hydraulic drive and control system for sequentially rapidly advancing with a low force an output member, advancing the output member at a high force with a low speed, and rapidly retracting the output member with a low force.

The regenerative hydraulic force assist eliminates pumps and intensifiers and converts deceleration and gravitational forces into fluid pressure in an accumulator. The pressure in the accumulator is used to generate the high force during the low speed displacement of the output member.

Although the regenerative hydraulic force assist is a part of the hydraulic drive, it is treated separately because of its novelty and potential application to other drives. The invention resides in the ability of its components to separately and in combination provide the numerous and substantial benefits disclosed herein.

The hybrid drive is comprised of a mechanical ball or roller screw and nut drive, an electric motor for actuating the ball or roller screw and nut drive, a hydraulic drive which is integrated with the ball or roller screw and nut drive, a regenerative hydraulic force assist which is operatively connected to the hybrid drive and a control system for controlling the hybrid drive and regenerative hydraulic force assist.

In employing the teachings of the present invention, a plurality of alternate constructions can be provided to achieve the desired results and capabilities. In this disclosure, only several embodiments are presented for the purpose of disclosing my invention. However, these embodiments are intended as examples only and should not be considered as limiting the scope of my invention.

The foregoing features, benefits, objects and best mode of practicing the invention and additional benefits and objects will become apparent from the ensuing detailed descriptions of preferred embodiments. The subject matter in which exclusive property rights are claimed is set forth in the numbered claims which are appended to the detailed descriptions of the preferred embodiments.

### BRIEF DESCRIPTION OF THE DRAWINGS

The invention will be better understood and further objects, characterizing features, details and advantages thereof will appear more clearly with reference to the diagrammatic drawings illustrating presently preferred specific embodiments of the invention by way of non-limiting examples only.

FIG. 1 is a schematic view of a machine drive according to the present invention.

FIG. 2 is a schematic view of a second form of the machine drive

FIG. 3 is a schematic view of a third form of the machine drive

FIG. 4 shows a three platen press with the FIG. 1 hybrid drive. This arrangement is typically used for metal and non-metal forming and trimming; also, for clamping dies internally containing metals and non-metals.

FIG. 5 shows a four platen press with a pair of FIG. 1 drives. This arrangement is typically used for thermo-forming, compression molding, injection molding and compacting powder metal presses.

FIG. 6 shows a two platen press with the FIG. 3 drive. This arrangement is typically used for clamping dies internally containing both metal and synthetic materials, i.e. plastics.

### DETAILED DESCRIPTIONS OF PREFERRED EMBODIMENTS

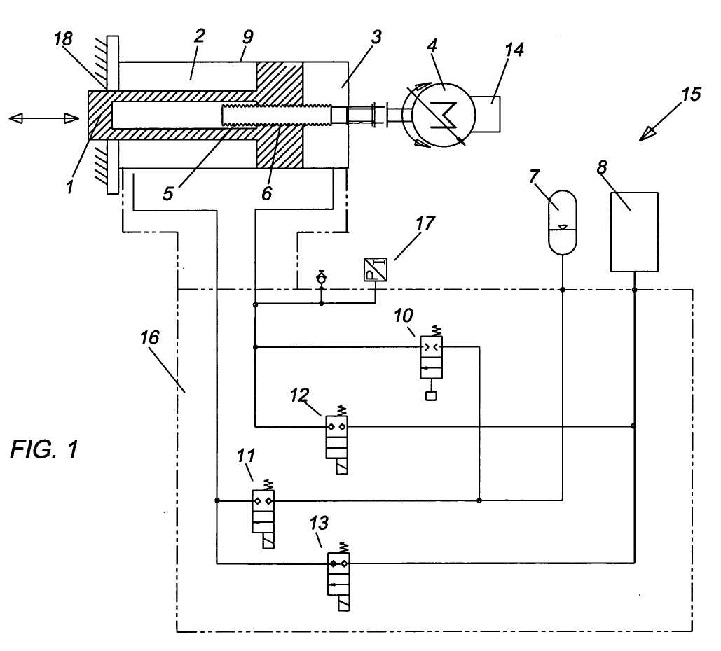

### First Embodiment (FIG. 1)

Referring now to the drawings wherein like numerals designate like and corresponding parts throughout the several views, in FIG. 1 a hybrid machine drive 15 is shown according to the present invention.

As used in the description, the term “hybrid drive” refers to a mechanical-hydraulic drive for sequentially displacing an output member of a single, dual and multiple action machine in three stages; i.e., a high speed low force first stage, followed by a low speed high force stage in the same direction as the first stage, followed by a high speed low force stage in a second direction which is opposite to the first stage. The term “action” refers to an action of a machine such as a “stamping press” or an action of a machine output member such as a ram of a “stamping press”. The terms “horizontal”, “rightward” “upward”, “rightwardly”, “leftwardly”, “downward” and “downwardly” refer to orientations in a particular drawing figure that faces the reader. Similarly, the terms “inward”, “inwardly”, “outward” and “outwardly” refer to the orientation of a surface relative to its axis of elongation, or axis of rotation, as appropriate. The terms “ball screw drive”, “ball screw and nut drive”, “roller screw drive” and “roller screw and nut drive” refer to a drive in which a ball nut is axially displaced by a roller or ball screw.

The numeral 15 designates a hybrid drive which has an output member 1 that displaces a machine member, such as a ram or a palette (not shown) in opposite horizontal directions relative to a stationary member 18 in response to a command signal supplied by a controller/motor 4. The controller which can be separate or part of a controller/motor 4 as shown in FIG. 1, provides current to the motor of the controller/motor 4. An external threaded portion of a controller/motor output shaft 5 engages an axially translating nut 6. The threaded output shaft 5 and translating nut 6 form a mechanical drive, commonly referred to as a ball screw and nut actuator or drive. The drive may also be a roller screw and nut drive (not shown). Numerals 10, 11, 12 and 13 designate solenoid valves which control the flow of oil between the hydraulic cylinder 9, accumulator 7 and fluid reservoir 8.

A feedback encoder 14 senses either the position or velocity, as appropriate, of the output member 1 relative to the stationary member 18. The ball screw and nut drive displaces the output member 1 in opposite horizontal directions at a high velocity during rotations of the motor output shaft 5. The hybrid drive 15 also has a hydraulic cylinder drive portion 9 that is arranged to generate a high force and concurrently displace the output member 1 at an end portion of a stroke of the output member 1 at a velocity set by valve 10 from a signal of a feed back encoder 14 and/or a force/pressure set by valve 10 with feedback pressure transducer 17. The velocity and force of the output member 1 can also be set by manual flow valves and/or pressure valves without feed back.

### Leftward Low Force, High Speed Displacement of Output Member

The mechanical drive portion displaces the output member 1 leftwardly at a high speed relative to the stationary member 18. At the same time the output member 1 is displaced leftwardly at a high speed, deceleration and gravity forces of the output member 1 transfer fluid from chamber 2 of the hydraulic cylinder 9 through solenoid valve 11 to the accumulator 7 causing the pressure in the accumulator 7 to increase in accordance with the gas charge in accumulator 7. Also, as the output member 1 moves leftward, fluid flows through solenoid valve 12 from a low pressure fluid reservoir 8 into a chamber 3.

### Leftward High Force & Low Speed Displacement of Output Member

Following the high speed leftward displacement of the output member 1, there is a low speed displacement of the output member 1 during which the ball screw and nut (mechanical) drive and a flow of fluid from the accumulator 7 (hydraulic drive) through valve 10 cooperate to move the output member 1 leftward relative to the stationary member 18 at a low speed and a high force. At the same time fluid flows through solenoid valve 13 into the low pressure reservoir 8.

### Rightward High Speed & Low Force Displacement of Output Member

Following the low speed high force displacement of the output member 1, there is a high speed and low force displacement of the output member 1 during which the ball screw and nut drive moves the output member 1 rightward relative to the stationary member 18 at a high speed and a low force. At the same time fluid is transferred by the movement of the output member 1 from chamber 3 into chamber 2 of the hydraulic cylinder 9 and into the low pressure reservoir 8.

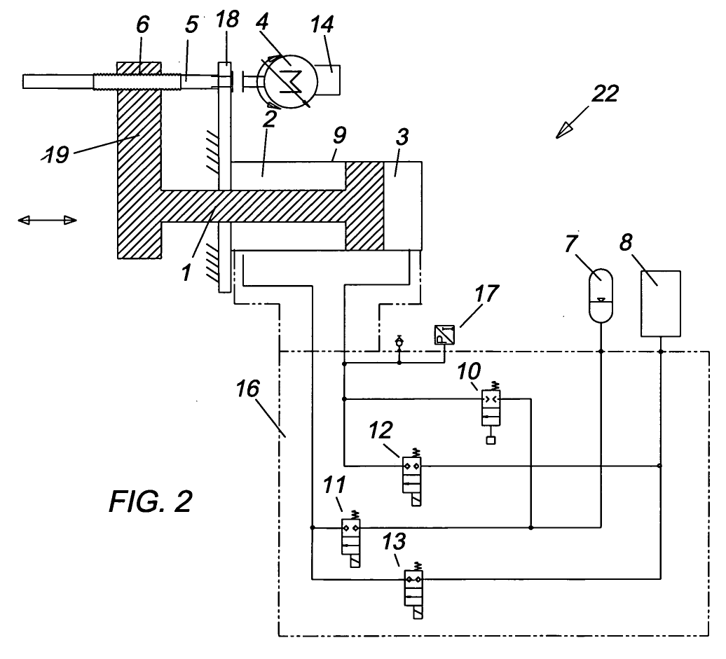

### Second Embodiment (FIG. 2)

Referring now to FIG. 2, a hybrid drive 22 is shown which is similar to the first embodiment, except that the ball screw and nut (mechanical) drive portion is external to the hydraulic cylinder 9, accumulator 7 and fluid reservoir 8 (hydraulic) drive portion. The ball screw and nut drive (shaft 5 and nut 6) is integrated into a moving platen 19 instead of output member 1.

The hybrid drive 22 is also shown as having an accumulator 7 that is operatively arranged to displace the output member 1.

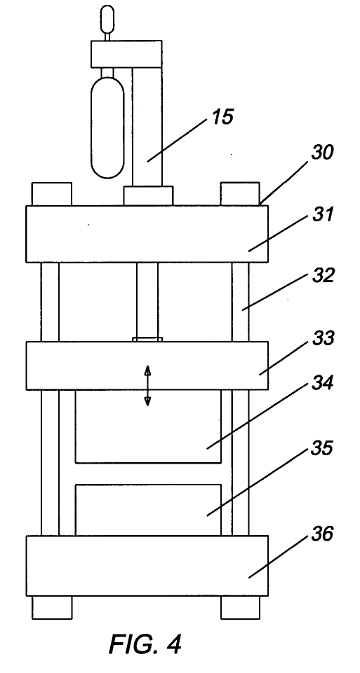

### Third Embodiment (FIG. 4)

Referring now to the drawing FIG. 4, a vertical three platen press (which could be a horizontal press) is shown based on the hybrid drive 15 of FIG. 1. The hybrid three platen press, however, could be horizontal instead of vertical. The hybrid drive 15 is fixed to an upper stationary platen 31. The hybrid drive's output member is fixed a moving platen 33 and an upper die/mold half 34 is fixed to the moving platen. The high-speed low force and low-speed high force displacements are upward and downward. The hybrid drive's output member, moving platen 33 and upper die/mold half 34 are accelerated downwardly by gravitational and drive forces. A lower fixed platen 36 and attached die/mold half 35 are attached to the fixed upper platen by tie rods 32 and nuts 30.

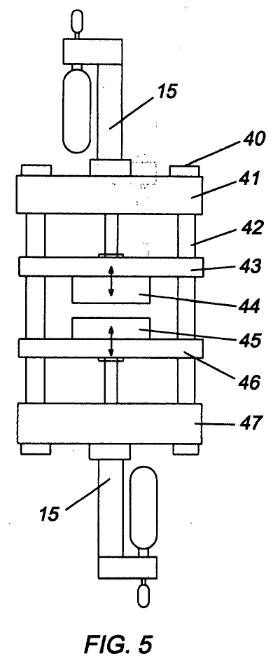

### Fourth Embodiment (FIG. 5)

Referring now to the drawing FIG. 5, a four vertical platen press that could be horizontal incorporates two hybrid drives 15. The first hybrid drive is fixed to an upper stationary platen 41. The hybrid drive output member is fixed to a moving platen 43 and the upper die/mold half 44 is fixed to the moving platen. High-speed low force and low-speed high force movements are upwardly and downwardly.

The second hybrid drive is fixed to a bottom stationary platen 47. The hybrid drive's output member is fixed to a moving platen 46 and a lower die/mold half 45 is fixed to a moving platen 46. High-speed low force and low-speed high force movements are upwardly and downwardly The two fixed platens 47 & 41 are attached to each other by tie rods 42 and nuts 40.

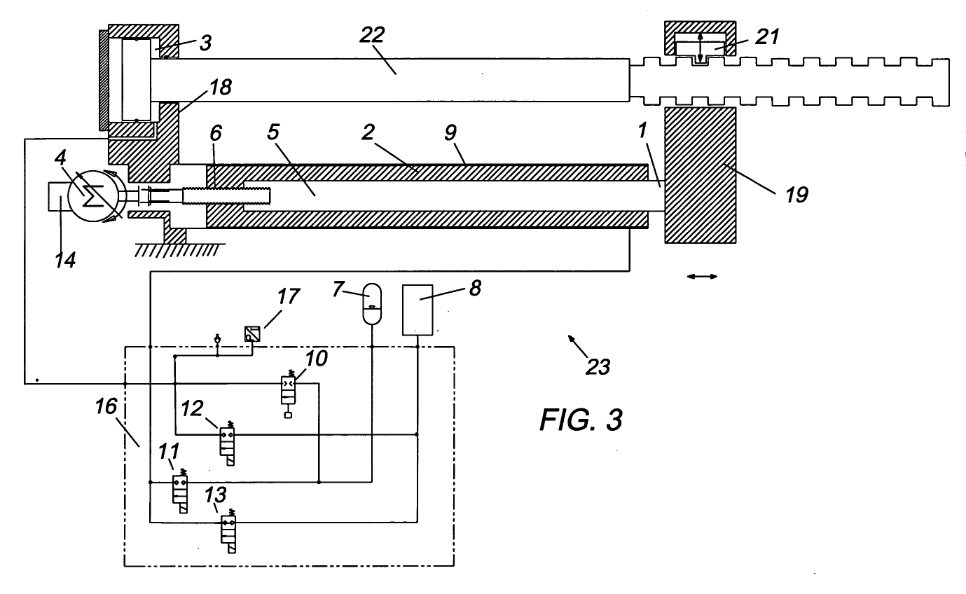

### Fifth Embodiment (FIG. 3)

Referring now to FIG. 3, a hybrid drive according to the invention is generally designated by the numeral 23. The embodiment in FIG. 3 is similar to the embodiment of FIG. 2, except for a second hybrid drive having an engaging device 21, which connects an output member 1 to a moving platen 19 during the low speed & high force movement.

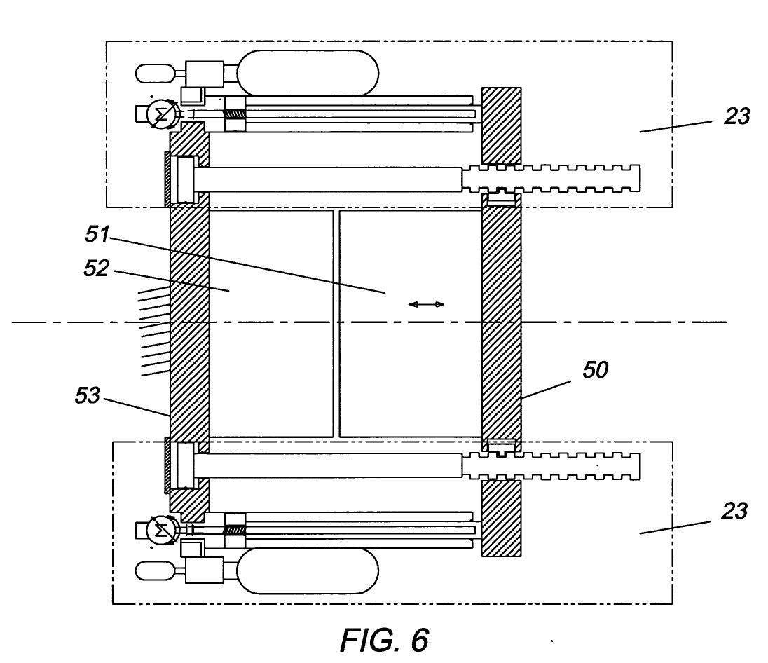

### Sixth Embodiment (FIG. 6)

Referring now to FIG. 6, a pair of hybrid drives 23 are shown for a horizontal or vertical dual action (two platen press). The hybrid drives 23 are fixed to a stationary platen 53 and one-half of a die or mold 52. An output member 50 is fixed by means of an engaging device to the moving platen 50 and the leftward die/mold half 51 is fixed to the moving platen 50. High-speed low force and low-speed high force movements occur leftwardly and rightwardly.

From the above, it will be apparent that my invention provides a machine and a drive, each having numerous important benefits over machines and drives in the prior art. One important benefit is that energy consumption is reduced thereby reducing operating costs. Another important benefit is that machine weight and size are reduced, thereby reducing investment costs. Another important benefit is that hydraulic pumps and intensifiers are eliminated, thereby further reducing operating and investment costs. Another benefit is that machine cycle times are reduced, thereby reducing the number of machines and employees at a given facility.

Although only several embodiments of my invention have been disclosed and described it is not my intention to limit my invention to the disclosed embodiments since having the benefit of my disclosures other embodiments can be derived by changes known to persons skilled in the art, such as the addition, elimination, substitution and arrangement of parts without departing from the spirit thereof. For example, it is obvious there are a number of mechanical drives known to persons skilled in the art that could be used in place of a roller or ball screw drive.

What I claim is new is:

1. In a mechanical-hydraulic machine for forming, shaping, molding and casting materials of the class wherein an output member is sequentially displaced in a first direction and thereafter in an opposite direction, the improvement comprising: at least one integrated hybrid drive for reducing the weight, size, cost and improving the performance of said machine by sharing components of a mechanical drive with a hydraulic drive, said hybrid drive comprising a mechanical drive for rapidly displacing at a low force an output member of said drive, a hydraulic drive for sequentially displacing at a high force and low speed said output member; and a regenerative hydraulic force assist for reducing energy consumption and eliminating pumps and intensifiers by regenerating gravitational and deceleration forces which occur during said displacements of said output member; and a closed loop control system for controlling the operation of said hybrid drive and said regenerative hydraulic force assist.

2. The improvement recited in claim 1 wherein said mechanical drive is comprised of said output member; a ball screw and nut drive for sequentially displacing said output member in a first direction and thereafter displacing said output member in a second opposite direction, said ball screw and nut drive including a ball nut and a ball screw threadably engaged with said screw; an electric motor for rotating said ball screw to displace said ball nut and said output member operatively connected to said ball nut, said motor responsive to a command signal from a controller to receive current for said rotation of said ball screw.

3. The improvement recited in claim 1 wherein said hydraulic drive is comprised of said output member, a piston operably connected to said output member and a hydraulic cylinder for receiving fluid to displace said output member.

4. The improvement recited in claim 2 wherein said output member is common with an output member of said hydraulic drive; said housing is common with a cylinder of said hydraulic drive; and a ball nut of a ball screw and ball nut assembly is common with a piston of said hydraulic drive.

5. The improvement recited in claim 1 wherein said control system is comprised of a controller for supplying current to said electric motor, a plurality of solenoid valves, and at least one feedback transducer capable of measuring the force, displacement or velocity of said output member relative to a stationary member; and a feedback encoder for sensing the position or velocity of the output member relative to said stationary member.

6. The improvement recited in claim 1 wherein said regenerative hydraulic force assist for reducing energy consumption and eliminating pumps and intensifiers is comprised of an accumulator, a fluid reservoir, a feedback encoder, a feedback pressure transducer and a plurality of valves for receiving signals from said feedback encoder and said feedback pressure transducer to control a flow of fluid into and out of said accumulator and said fluid reservoir.

7. The improvement recited in claim 1 wherein said machine is a single acting machine.

8. The improvement recited in claim 1 wherein said machine is a double acting machine.

9. The improvement recited in claim 1 wherein said machine is a multiple acting machine.

10. An integrated hybrid drive with a regenerative hydraulic force assist for reducing the weight, size, cost and improving the performance of said machine by sharing components of said machine and conserving energy by eliminating hydraulic pumps and intensifiers and regenerating deceleration and gravitational forces of said machine into forces of an output member of said drive, said hybrid drive comprising a mechanical drive for rapidly displacing at a low force said output member of said drive; a hydraulic drive for sequentially displacing at a high force and low speed said output member, said hydraulic drive having components that are common with said mechanical drive, said regenerative hydraulic force assist comprising an accumulator, a fluid reservoir, a feedback encoder, a feedback pressure transducer and a plurality of valves for receiving signals from said feedback encoder and said feedback pressure transducer to control a flow of fluid into and out of said accumulator and said fluid reservoir.

11. The hybrid drive recited in claim 10 wherein said mechanical drive is comprised of said output member; a ball screw and nut drive for displacing said output member, said ball screw and nut drive including a ball nut and a ball screw threadably engaged with said screw; an electric motor for rotating said ball screw to displace said ball nut; said motor responsive to a command signal from a controller to receive current for rotating said ball screw; and a housing for enclosing said ball screw and nut drive.

12. The hybrid drive recited in claim 10 wherein said mechanical drive is comprised of said output member; a linear motor for said rapid displacement of said output member; said motor responsive to a command signal from a controller to receive current for a linear movement of said motor.

13. The hybrid drive recited in claim 10 wherein said hydraulic drive is comprised of said output member, a piston operatively connected to said output member and a hydraulic cylinder for receiving fluid to displace said output member.

14. The hybrid drive recited in claim 11 wherein said output member is common with an output member of said hydraulic drive, said housing is common with a hydraulic cylinder of said hydraulic drive and said ball nut is common with a piston of said hydraulic drive.

15. The hybrid drive recited in claim 11 further comprising a closed loop control system, said control system having a controller for supplying current to an electric motor, a plurality of solenoid valves; at least one feedback transducer capable of measuring the force, displacement or velocity of said output member relative to a stationary member; and a feedback encoder for sensing the position or velocity of said output member relative to said stationary member.

16. A hybrid drive for displacing an output member of a single, dual or multiple action machine, said hybrid drive comprising: a mechanical means for advancing said output member in a said first direction at a high speed and low force; a hydraulic means for sequentially advancing said output member in said first direction at a low force and high speed; a mechanical means for advancing said output member at a high speed and low force in a second direction which is opposite to said first direction; and a regenerative force assist.

17. The hybrid drive recited in claim 16 wherein said mechanical means is a mechanical ball screw and ball nut drive.

18. The hybrid drive recited in claim 16 wherein said mechanical means is a mechanical roller screw and nut drive.

19. The hybrid drive recited in claim 16 wherein said mechanical means is a mechanical output member of a linear motor.

20. The hybrid drive recited in claim 16 wherein said mechanical advancing means is external to said hydraulic advancing means.

21. The hybrid drive recited in claim 19 further comprising an engaging member for coupling said mechanical advancing means to said hydraulic advancing means.
